(19) United States
(12) Patent Application Publication
(10) Pub. No.: US 2015/0072797 A1
(43) Pub. Date: Mar. 12, 2015

(54) Terminal Device and Display Method

(71) Applicant: ACCESS CO., LTD, Chiba (JP)

(72) Inventors: Daisuke Sakyo, Tokyo (JP); Shigenori Mogi, Tokyo (JP)

(73) Assignee: ACCESS CO., LTD., Chiba (JP)

(21) Appl. No.: 14/479,747

(22) Filed: Sep. 8, 2014

Related U.S. Application Data
(60) Provisional application No. 61/875,462, filed on Sep. 9, 2013.

(51) Int. Cl. A63B 24/00; A63B 71/06; G09G 5/377

(52) U.S. Cl. CPC A63B 24/0006; G09G 5/377; A63B 71/0619; G09G 2340/125; A63B 2071/0647; A63B 2069/3602
USPC 473/223; 345/629; 473/453; 473/461

(57) ABSTRACT

One embodiment of a terminal device according to the present invention comprises a moving image acquiring means for acquiring the moving image of a measured subject on which a sensor is installed, a sensor data acquisition means for acquiring sensor data from the sensor about said measured subject and a display control means for overlaying and displaying said moving image and additional images that are generated from said sensor data. The embodiment provides a terminal device capable of effectively checking a player's motion.

### CROSS-REFERENCE TO RELATED APPLICATIONS

This application claims the benefit of U.S. Provisional Application No. 61/875,462, filed Sep. 9, 2013, titled “Generating and Displaying Three-Dimensional Swinging Action,” which is hereby incorporated by reference.

### FIELD OF TECHNOLOGY

The present invention relates to a terminal device for analyzing the motion of a player engaged in an athletic sport and the like.

### BACKGROUND

An example of a terminal device that is known for analyzing the swing (motion) of a player is a terminal device that uses data received from a motion sensor that is installed on a golf club for visualization of the player's swing trace (motion) (see Non-Patent Literature 1).

### PRIOR ART LITERATURE

### Non-Patent Literature

Non-Patent Literature 1: “Fullmiere”, [online], 2013, ACCESS Co., Ltd., (searched on Mar. 1, 2014), Internet <URL: http://www.fullmiere.com/>

### SUMMARY

### Problems to Be Solved by the Invention

With the afore-described previous terminal device, a player can check his swing trace (motion) that is displayed on a screen. However, there is a need for a terminal device that allows a player to more effectively check his own motion. To address this need, the various embodiments of the present invention provide a terminal device that allows a player's motion to be effectively checked.

### Means for Solving the Problem

One embodiment of a terminal device according to the present invention includes: a moving image acquiring means for acquiring a moving image of a measured subject on which a sensor is installed; a sensor data acquisition means for acquiring sensor data related to the measured subject from the sensor; and a display control means for overlaying and displaying the moving image and additional images generated from the sensor data. One embodiment of a program according to the present invention causes a computer to function as: a moving image acquiring means for acquiring moving images of a measured subject on which a sensor is installed; a sensor data acquisition means for acquiring sensor data related to the measured subject from the sensor; and a display control means for overlaying and displaying the moving image and additional images generated from the sensor data. One embodiment of a display method according to the present invention comprises: a step for acquiring moving images of a measured subject on which a sensor is installed; a step for acquiring sensor data related to the measured subject from the sensor; and a step for overlaying and displaying the moving images and additional images generated from the sensor data.

### Effects of the Invention

The various embodiments of the present invention provide a terminal device for effectively checking a player's motion.

### BRIEF DESCRIPTION OF THE DRAWINGS

The foregoing and other features of the present disclosure will become more fully apparent from the following description and appended claims (exemplary embodiments) taken in conjunction with the accompanying drawings. Understanding that these drawings depict only several embodiments in accordance with the disclosure and are therefore, not to be considered limiting of its scope, the disclosure will be described with additional specificity and detail through use of the accompanying drawings.

FIG. 1 is a block diagram showing the configuration of sensor 100 that is included in one embodiment of an analysis system according to the present invention.

FIG. 2 is a block diagram showing the configuration of camera 200 that is included in one embodiment of an analysis system according to the present invention.

FIG. 3 is a block diagram showing the configuration of terminal device 300 that is included in one embodiment of an analysis system according to the present invention.

FIG. 4 is a schematic diagram showing sensor 100 that is included in one embodiment of an analysis system according to the present invention and installed on a golf club.

FIG. 5 is a flowchart showing the operation of one embodiment of an analysis system according to the present invention.

FIG. 6A shows a schematic view of an example of a preview screen from a front view that may be displayed on preview display unit 250 of camera 200 in one embodiment of an analysis system according to the present invention.

FIG. 6B shows a schematic view of an example of a preview screen from a back view that may be displayed on a preview display unit 250 of camera 200 in one embodiment of an analysis system according to the present invention.

FIG. 6C shows a schematic view of an example of a preview screen from a side view that may be displayed on a preview display unit 250 of camera 200 in one embodiment of an analysis system according to the present invention.

FIG. 6D shows a schematic view of an example of a preview screen from a side view that may be displayed on a preview display unit 250 of camera 200 in one embodiment of an analysis system according to the present invention.

FIG. 7A schematically shows the appropriate distance between a player and camera 200 in one embodiment of an analysis system according to the present invention when camera 200 is positioned horizontally, from a side view.

FIG. 7B schematically shows the appropriate distance between a player and camera 200 in one embodiment of an analysis system according to the present invention when camera 200 is positioned horizontally, from a bird's eye view.

FIG. 8A schematically shows the situation where the height of the subject captured by the camera becomes the tallest in one embodiment of an analysis system according to the present invention.

FIG. 8B schematically shows the how the top of the swing does not correspond to the situation where the height of the subject captured by the camera is the tallest in one embodiment of an analysis system according to the present invention.

FIG. 9A schematically shows the appropriate distance between a player and camera 200 in one embodiment of an analysis system according to the present invention when camera 200 is not positioned horizontally, from a side view.

FIG. 9B schematically shows the appropriate distance between a player and camera 200 in one embodiment of an analysis system according to the present invention when camera 200 is not positioned horizontally, from a bird's eye view.

FIG. 10 shows one example of a screen that is displayed on display unit 350 of terminal device 300 in one embodiment of an analysis system according to the present invention.

FIG. 11 shows another example of a screen that is displayed on display unit 350 of terminal device 300 in one embodiment of an analysis system according to the present invention.

FIG. 12 schematically shows the ideal posture of a player when swinging a golf club in one embodiment of an analysis system according to the present invention.

FIG. 13A shows the program flow in one embodiment of an analysis system according to the present invention from the start of measurement of a swing until the completion of the process for overlaying the recorded data and the coordinates of a moving image showing a swing trace.

FIG. 13B shows the program flow in one embodiment of an analysis system according to the present invention from the start of measurement of a swing until the completion of the process for overlaying the recorded data and the coordinates of a moving image showing a swing trace.

FIG. 14 shows another screen that is displayed on display unit 350 of terminal device 300 in one embodiment of an analysis system according to the present invention.

FIG. 15 is a flowchart showing the process used by a program for positioning the line segments shown in FIG. 14 in a screen rendering region when overlaying the line segments onto a moving image on a screen.

FIG. 16 shows the waveforms of the sensor data of the acceleration sensor in the Y-axis direction and the sensor data of the angular velocity sensor in the X-axis and Z-axis directions of motion sensor 100 when a golf club installed with the sensor is swung.

### DETAILED DESCRIPTION

Different embodiments of the present invention are described next with reference to the attached drawings. The same reference numbers are used for the same elements in the attached drawings.

In the description hereinbelow, examples of a terminal device used for the analysis of the swing of a player holding a golf club are mobile phones, smartphones, portable information terminals, laptop computers and the like.

One embodiment of the analysis system according to the present invention includes sensor 100 that is installed on a golf club being measured, camera (image capturing unit) 200 for generating the moving image of a player holding and swinging the golf club, and a terminal device 300 that is connected to sensor 100 and camera 200.

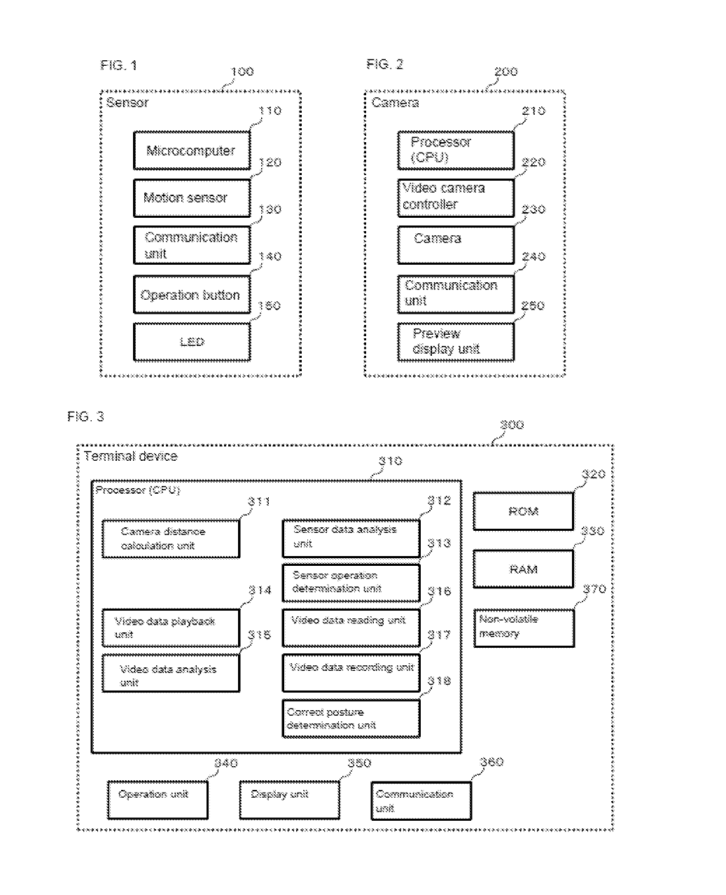

FIG. 1 is a block diagram showing the configuration of sensor 100 that is included in the analysis system in one embodiment of the present invention. FIG. 2 is a block diagram showing the configuration of camera 200 that is included in the analysis system in one embodiment of the present invention. FIG. 3 is a block diagram showing the configuration of terminal device 300 that is included in the analysis system in one embodiment of the present invention.

Referring to FIG. 1, sensor 100 includes microcomputer (CPU) 110, motion sensor 120, communication unit 130, operation button 140 and LED 150.

Motion sensor 120 includes acceleration sensors for detecting acceleration in three axial directions (X-axis, Y-axis and Z-axis) and angular velocity sensors for detecting angular velocities in the three axial directions. Motion sensor 120 may further include a geomagnetism sensor.

Microcomputer (CPU) 110 controls the different components included in sensor 100. Microcomputer 110 also synchronizes the different data that is detected by motion sensor 120 and outputs the data as sensor data to communication unit 130 after performing processes such as temperature correction and bias correction on the data. Microcomputer 110 also performs other processes.

Communication unit 130 engages in, for example, a narrow-band wireless communication with terminal device 300 to send and receive data. (The communication can also be a broadband communication.) Narrow-band wireless communication means a wireless communication that uses Bluetooth (registered trademark), wireless LAN and the like.

The function of operation button 140 is to initiate data transmission and reception between sensor 100 and terminal device 300 when operation button 140 is pressed by a player. LED 150 is lit depending on factors such as whether or not terminal device 300 is ready to start analysis and whether or not communication error has occurred between sensor 100 and terminal device 300. This allows the player to determine before a swing is started as to whether the measurement of the swing can be continued simply by checking the lit state of LED 150 and without looking at an error screen or operation instructions and the like that are displayed on the display unit of terminal device 300.

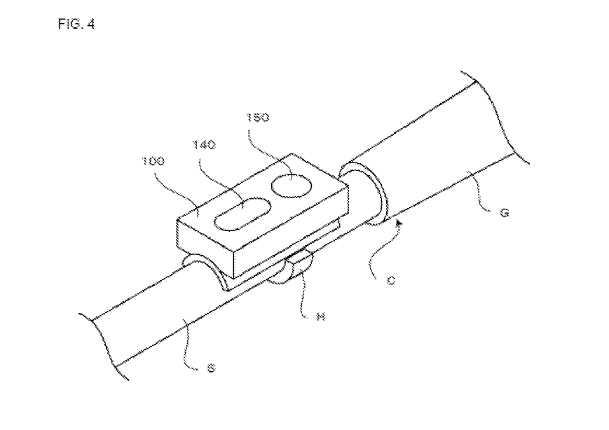

Sensor 100 having the afore-described configuration is removably installed, for example, near the border between grip G and shaft S of a golf club as shown in FIG. 4. The sensor 100 is fixed to golf club C by holder H consisting of a rubber band or the like so that sensor 100 does not become dislodged from golf club C from the swing or the impact of hitting a golf ball.

Next, as shown in FIG. 2, camera 200 includes processing unit (CPU) 210, video camera control unit 220, camera unit 230, communication unit 240 and preview display unit 250.

The video camera unit 220 controls camera unit 230. Camera unit 230 comprises a plurality of image capturing devices and is controlled by video camera unit 220 to perform an image capturing process that generates static images and/or moving images that are output to communication unit 240.

The processing unit (CPU) 210 controls the various components in camera 200. The processing unit 210 also performs other processes.

Communication unit 240 engages in, for example, a narrow-band wireless communication with terminal device 300 to send and receive data. (The communication can also be a broadband communication.) Narrow-band wireless communication means a wireless communication that uses Bluetooth (registered trademark), wireless LAN and the like. The preview display unit 250 displays preview images and the like, which are further described below.

Next, as shown in FIG. 3, terminal device 300 includes processing unit (CPU) 310, ROM 320, RAM 330, operation unit 340, display unit 350, communication unit 360 and non-volatile memory 370.

ROM 320 is a memory device that stores an application (hereinafter referred to for simplicity sake as “the specific application”) used for swing analysis and the like and also stores the system capable of executing the specific application. The application and the system (i.e., the many commands that constitute the application and the system) are loaded into CPU 310 where they are executed. RAM 330 is a memory device that is used for reading and writing data while the application and the system (i.e., the many commands that constitute the application and the system) that are stored in ROM 320 are executed by CPU.

Operation unit 340 is an input unit, which receives the operation entered by a player (user). The information that is input through operation unit 340 is provided to the specific application via the system that executes the specific application. Display unit 350 displays various information such as text, icons, buttons and other components and video data that is played back as instructed by the specific application and the system that executes the specific application. Incidentally, the terminal device 300 can be configured so that information that can be displayed on display unit 350 is displayed, not on display unit 350, but on a display device that is separate from terminal device 300. Communication unit 360 engages in a narrow-band wireless communication with sensor 100 and camera 200 to send and receive data. (The communication can be a broadband communication.) Non-volatile memory 370 is a memory device that is used by the specific application and the system that executes the specific application for reading and writing data. The data that is written to non-volatile memory 370 remains stored therein even after the specific application and the system executing the specific application are terminated.

The processing unit (CPU) 310 performs various processes related to swing analysis and the like and includes such functional blocks as the camera distance calculation unit 311, sensor data analysis unit 312, sensor operation determination unit 313, video data playback unit 314, video data analysis unit 315, video data reading unit 316, video data recording unit 317 and correct posture determination unit 318.

The camera distance calculation unit 311 is a program block that is installed in the specific application for calculating the appropriate distance between camera 200 and the player required for recording the swing and measuring the swing trace. The sensor data analysis unit 312 is a program block that is installed in the specific application for analyzing the sensor data that is received from sensor 100 and converting the sensor data to data about the swing. When a swing is to be measured, the sensor operation determination unit 313 is a program block that determines the nature of the operation that is performed on operation button 140 and received from sensor 100 via communication unit 360.

The video data playback unit 314 is a program block for rendering on display unit 350 the video data (moving image) that is generated by camera 200. The video data analysis unit 315 is a program block for analyzing the video data (moving image) that is generated by camera 200 and uses data about a swing received from sensor data analysis unit 312 to trim a moving image. The video data recording unit 317 is a program block for associating the video data trimmed by video data analysis unit 315 and data about the swing generated by sensor data analysis unit 312 and for recording the associated result in non-volatile memory 370. The video data reading unit 316 is a program block for reading the video data (moving image) that is stored in non-volatile memory 370 by video data recording unit 317 and for storing the video data in RAM 330. The correct posture determination unit 318 is a program block that uses the height of the player, the length of the club and the lie angle of the club at the time a swing is started to calculate a correct posture.

FIG. 2 and FIG. 3 show the configuration wherein camera 200 shown in FIG. 2 is disposed externally to terminal device 300 shown in FIG. 3, that is, where camera 200 is provided separately from terminal device 300. However, it is also possible to use a configuration wherein camera 200 is disposed internally within terminal device 300 as a part of terminal device 300. If the internalized configuration is used, the data transmission and reception that occur between communication unit 360 and communication unit 240 occur instead between processing unit 310 and video data recording unit 317, the preview display unit 250 is included within display unit 350, and processing unit (CPU) 300 is included within processing unit (CPU) 310.

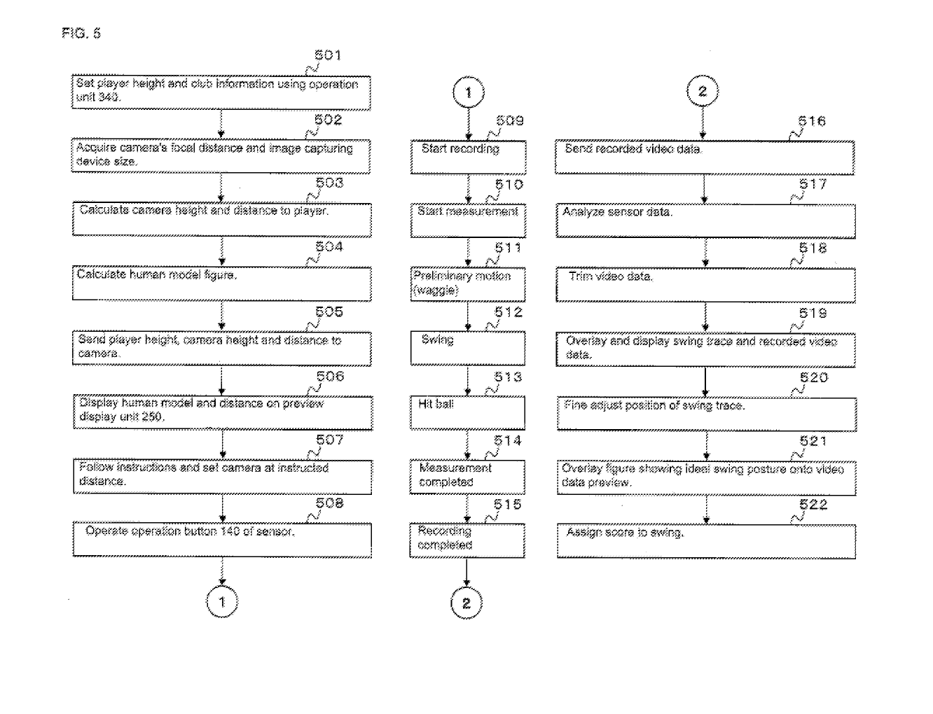

Next, the operations performed by the analysis system having the afore-described configuration are described next with reference to FIG. 5, a flowchart showing the operations performed in one embodiment of an analysis system according to the present invention.

First, the program performs automatic adjustment in steps 501 through 507 so that the size of the circle traced by the clubhead that is depicted on display unit 350 of terminal device 300 is substantially equal to the size of the swing trace based on the sensor data that is depicted on display unit 350.

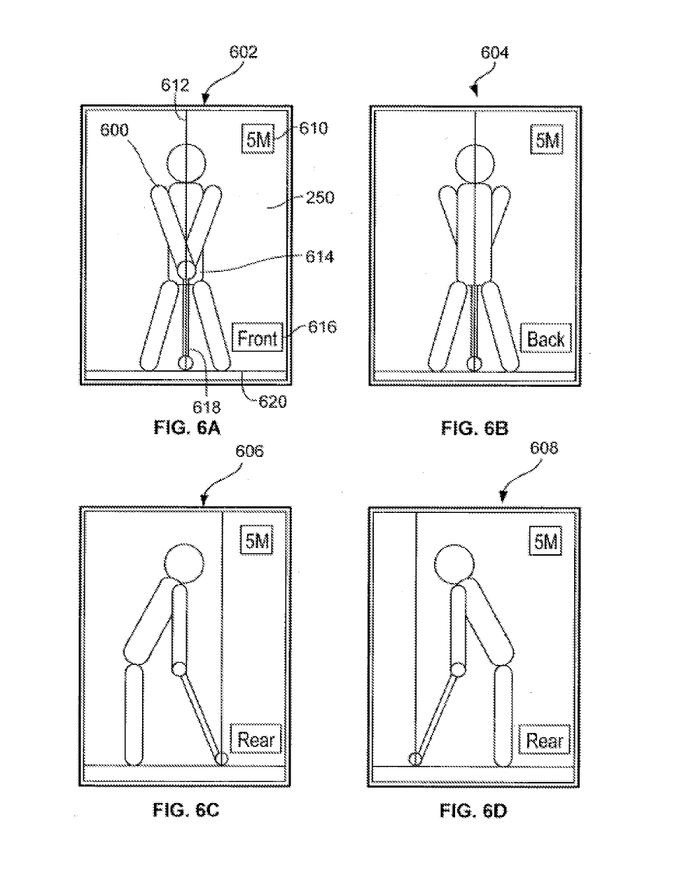

Then, before recording is started, the preview display unit 250 of camera 200 that is positioned to face the player displays a preview screen such as those shown in FIGS. 6(a) through FIG. 6(d) that depict the position of the player's head and standing position (that is, human model 600), the position of the golf ball and a horizontal line so as to invite the player to assume a correct standing position. FIG. 6(a) through FIG. 6(d) show examples of preview screens that are displayed on preview display unit 250 when the player is recorded from the front 602, back 604, rear (for a right-handed player) 606 and rear (for a left-handed player) 608, respectively. The preview screen that is displayed on preview display unit 250 displays a perpendicular line 612 for reference, and also displays at the top right position the proper distance 610 between the camera 200 and the player 600. Preview display unit 250 shows human silhouette 614 of player 600, ball position 618, and horizon 620. Preview display unit 250 may display the select recording orientation information 616.

Overlaid and displayed together with human model 600 and proper distance 610 on the preview screen is the image of the player that was captured by camera unit 230 of camera 200. This allows the player to stand at the proper standing position by looking at the preview.

The camera 200 can also be configured to sequentially send the preview image that is displayed on preview display unit 250 to communication unit 360 of terminal device 300 via communication unit 240 so that the same preview screen is displayed on display unit 350 of terminal device 300. This allows the player, even in the absence of a person (videographer) to operate camera 200, to maintain a proper distance to camera 200 and to stand at the proper standing position by looking at the preview screen that is displayed on display unit 350 of terminal device 300.

The proper distance 610 and human model 600 that are displayed on preview display unit 250 are calculated by camera distance calculation unit 311 at terminal device 300 shown in FIG. 3 and are sent by communication unit 360 to communication unit 240 of camera 200 shown in FIG. 2 and are displayed on preview display unit 250 of camera 200.

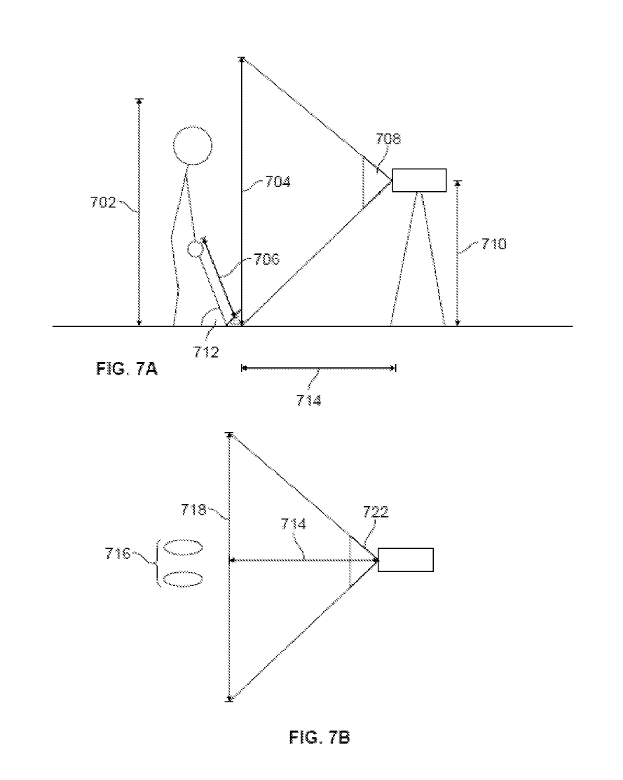

The camera distance calculation unit 311 calculates the proper distance between camera 200 and a player as follows. The calculation that is performed when camera 200 is not tilted and is positioned substantially parallel to the ground is described first with reference to FIG. 7A and FIG. 7B showing a side view FIG. 7A and a bird's eye view FIG. 7B. If the height of the camera 710 and its angle 708 are fixed, to determine the standing position 716 of the player the proper distance 714 between the player and camera 200 is calculated using equation (1) below based on club length 706, the height 702 of the subject, the focal distance of camera 200 and the size of the image capturing device of camera 200 so that the player and swing trace will fit within the screen.

Distance (m) 714 to the subject=(Focal distance (mm)×maximum height of the subject (mm) 704÷vertical size (mm) of image capturing device÷1000 (1)

The “maximum height of the subject” (MH) 704 in equation (1) above is calculated using equation (2) below:

MH=PH×0.42(grip reach from back)+CH×sin θ+(CH²+(PH×0.42)²)×sin θ (2)

where PH is the player's height (mm) 702, CH is club length (mm) 706 and θ 712 represents the angle formed between the club and the ground at address 712. Shown in FIG. 7B a horizontal angle 722 of view determines viewing angle width 718 in the horizontal direction.

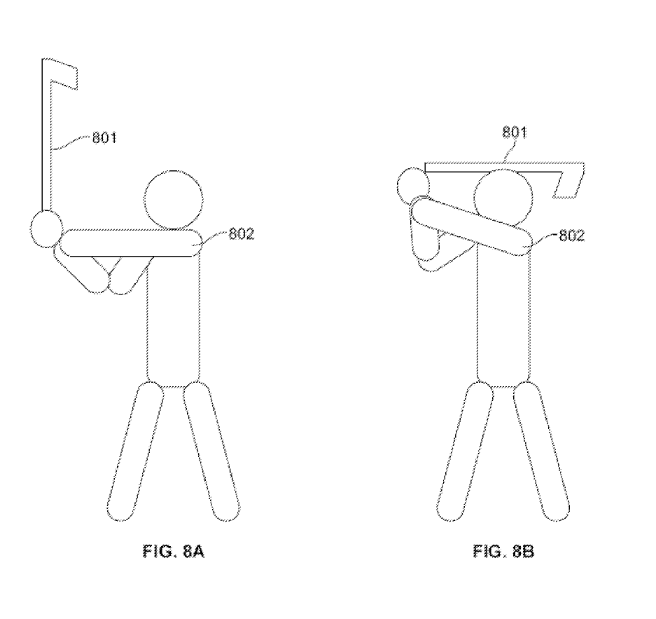

Referring to FIG. 8, the maximum height of the subject (MH) is considered to be reached at the position in a golf swing shown in FIG. 8(a). To explain, with a right-handed player, the maximum height of the subject is considered to be reached when left arm 802 is raised to the level of the tip of the shoulder to be substantially parallel to the ground and club 801 is extended to be perpendicular to the ground. The maximum height of the subject is not reached at the “top of the swing” shown in FIG. 8(b) since the clubhead of club 801 is pointed to the rear of the player's head and club 801 is extending substantially parallel to the ground. Stated otherwise, in a triangle whose two edges are formed by the club and the extension from the player's shoulder to the grip axis, the maximum height of the subject is reached when the long edge of the triangle is located along the center line of the player's body and is parallel to the lie angle at address. Even if, in an actual swing motion, the clubhead were not to be raised to the afore-described height, sufficient height is secured for containing the swing arc within the screen. Based on data for the Japanese population for 1991 and 1992, it is known that the grip reach from the back for both men and women is approximately 42% of the player's height (http://riodb.ibase.aist.go.jp/dhbodydb/91-92/). Since golf players generally do not know their grip reach from the back, the distance required for estimating the subject's height is calculated based on the player's height and the typical ratio (42%).

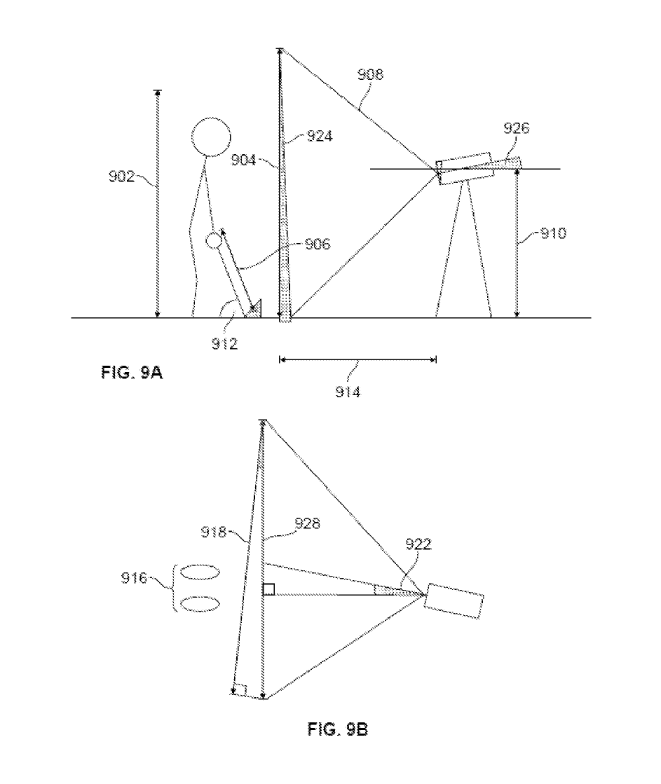

The calculation of the distance when camera 200 is tilted with respect to the ground is described next with reference to FIG. 9A and FIG. 9B. Letting (A) represent the tilt 926 of the camera, the triangle that is formed by the ground, the maximum height (B) 924 of the subject and the height of the image captured by the vertical angle of view 908 becomes similar to tilt (A) 926 of the camera. This means that the distance 914 to the subject when camera 200 is tilted can be calculated using equation (3) below:

Distance (m) 914 to the subject=Distance (m) to the subject calculated using equation (1) above+Maximum height 924 of the subject×tan Ψ (3)

where Ψ represents the angle formed between the camera and the ground. FIG. 9(B) shows a standing position 916 of player, horizontal direction width 918 when camera is parallel, and a horizontal direction width 928, depending on camera tilt 922.

Referring back to FIG. 5, so that the camera distance calculation unit 311 of terminal device 300 can calculate the proper distance that should be maintained between camera 200 and the player, the player uses the operation unit 340 of terminal device 300 to enter information about the player's height and the club that is used (e.g., the club length and the club angle at address) in step 501. The information that is entered becomes usable by the camera distance calculation unit 311 for calculating the proper distance. In step 502, the camera distance calculation unit 311 acquires information about the focal distance of camera 200 and the vertical size of the image capturing device of camera 200 either from camera 200 or from operations performed by the player using operation unit 340. Furthermore, in step 503, the camera distance calculation unit 311 calculates the height of camera 200 and the proper distance to be maintained between camera 200 and the player.

Next, in step 504, camera distance calculation unit 311 calculates the afore-described human model 600 based on information concerning the videographing direction (front, back, etc.) received from camera 200, information regarding the tilt of camera 200 and the information stored in advance in non-volatile memory 370 about whether the player is right-handed or left-handed.

Then, in step 505, the human model and the proper distance calculated by camera distance calculation unit 311, the player's height and the camera's height are sent to communication unit 240 of camera 200, and the human model and proper distance are displayed in step 506 as a preview screen on preview display unit 250 of camera 200 (and on display unit 350 of terminal device 300 if so configured). This allows the player, in step 507, to set up camera 200 to maintain the proper distance between the player and camera 200 based on the information that is displayed on preview display unit 250 of camera 200.

Then, the measurement of the swing using sensor 100 and the recording of the swing using camera 200 are performed in steps 508 through 515. First, in step 508, the player presses operation button 140 of sensor 100 prior to starting the swing. When sensor 100 detects that the player has pressed operation button 140, a signal (a first specific signal) indicating that is sent to terminal device 300 via communication unit 130. The terminal device 300 receives the first specific signal from sensor 100 via communication unit 360 and outputs the first specific signal to sensor operation determination unit 313. When the sensor operation determination unit 313 receives the first specific signal, this triggers the specific application that is being executed by CPU 310 to activate camera 200 in the recording mode in step 509. This causes camera 200 to start recording using camera unit 230 (and also allows the specific application to identify the time when operation button 140 of sensor 100 was pressed). The result is that the start of the swing by the player and the start of the recording by camera 200 are synchronized. Furthermore, the measurement of the swing by sensor 100 begins in step 510, triggered by the pressing of operation button 140 of sensor 100 in afore-described step 508.

In step 511, the player engages in a preliminary motion known as waggling. The player performs a swing in step 512 and hits a golf ball in step 513. When sensor 100 detects the impact (hitting) between the golf club and the golf ball, sensor 100 sends a signal (a second specific signal) to terminal device 300 via communication unit 130 and the measurement of the swing is stopped in step 514. When terminal device 300 receives the second specific signal from sensor 100, this triggers the specific application that is being executed by CPU 310 to stop in step 515 the recording performed by camera 200 (and allows the specific application to identify the time when impact occurred). The timing when recording by camera 200 is stopped is not substantially simultaneous with the timing of the impact. The timing when recording is stopped is suitably adjusted so that the recording stops after the swing by the player is completed. This synchronizes the completion of the player's swing and the completion of the recording.

In step 516, the recorded data (video data) generated by camera 200 is sent to and is stored by terminal device 300. The sensor data that is generated by sensor 100 is also sent to and stored by terminal device 300.

In step 517, the sensor data analysis unit 312 of terminal device 300 analyzes the stored sensor data. All of the series of commands and responses, and data that is sent and received in afore-described steps 508 through 515 among sensor 100, camera 200 and terminal device 300 are given a time stamp. The time stamps allow the time from step 512 through step 514 to be identified as the valid swing period. It is desirable to trim the recorded data while preserving the recorded data (video data) of the valid swing period. To perform trimming in this way, the sensor data analysis unit 312 uses the “waggle elimination method” disclosed by the Applicant in Japanese Patent Application No. 2012-254672 on the sensor data to identify the timing when the swing starts. This allows the sensor data analysis unit 312 to calculate the amount of time before the swing starts to delete from the recorded data. This calculation is based on the difference between the timing when the swing is started and the timing of step 509 until the timing of step 512 (all of which timings can be identified from the aforesaid time stamps).

The aforesaid “waggle elimination method” is briefly described here. This method entails detecting the starting point of a swing by removing the swing trace created by waggles from the sensor data and thereby not using the sensor data created by waggles for a swing analysis. FIG. 16 shows—in terms of the coordinate system of the angular velocity sensor—the waveforms of the sensor data for angular velocity in the X-axis and Z-axis directions and acceleration in the Y-axis direction obtained with angular velocity sensors and acceleration sensor of motion sensor 100 that is installed on a golf club that is swung. Starting from the data measurement starting point, the swing state determination unit detects the negative peak value Z1 in the Z-axis sensor data obtained from the angular velocity sensor and the positive peak value X1 in the X-axis sensor data obtained from the angular velocity sensor and stores both in RAM 330. Once impact point T1 is detected, the X-axis sensor data and Z-axis sensor data are traced back until such point that the sign becomes reversed from the signs of the peak values Z1 and X1 that are stored in RAM 330. Specifically, as shown in FIG. 16, point Z2 where the sign of the Z-axis sensor data changes from the negative peak value Z1 to a positive value and point X2 where the sign of the X-axis sensor data changes from the positive peak value X1 to a negative value are detected. Of the two detected points Z2 and X2, the one with a lesser number of measurement points between it and the data detection starting point is determined as the swing starting point S. In the swing data analysis process, the sensor data from the acceleration sensor prior to the swing starting point that is determined as afore-described is judged as solely acceleration due to gravity and is filtered out and is not used for the swing analysis. This increases the accuracy of the result of the analysis. Impact point T1 is detected from the waveform shown in FIG. 16 of the Y-axis acceleration data obtained from the acceleration sensor by a sudden deceleration or peak in the negative direction. Also, the striking of the golf ball at impact is believed to cause a momentary stop in motion that causes a large change in sensor data. This means that, in addition to the afore-described method, it is acceptable to determine that impact T1 has been detected when the difference in the waveform of successive Y-axis sensor data shown in FIG. 16 obtained from the acceleration sensor exceeds a predetermined value. Furthermore, the predetermined difference used for identifying impact can be modified for the type of golf club or golf ball that is used so that impact is accurately determined based on the impact associated with particular clubs and golf balls. The foregoing is a description of the waggle elimination method. The entirety of the information described in Japanese Patent Application No. 2012-254672 is incorporated herein by reference.

Referring again to FIG. 5, in step 518, the recorded data elimination period calculated in step 517 is used to remove unnecessary recorded data (that is, the recorded data representing from the start of recording until the completion of waggles) from the overall recorded data. Also, the timing when the swing begins in the recorded data and the timing for starting playback of the swing trace are synchronized. Because the same time stamps are provided at periodic intervals to the recorded data and sensor data, by recognizing the timing of the start of a swing in the sensor data, the same timing can be used as the timing for starting the playback of the recorded data, thus allowing synchronization between the timing when a swing is started in the recorded data and the timing for starting the playback of a swing trace.

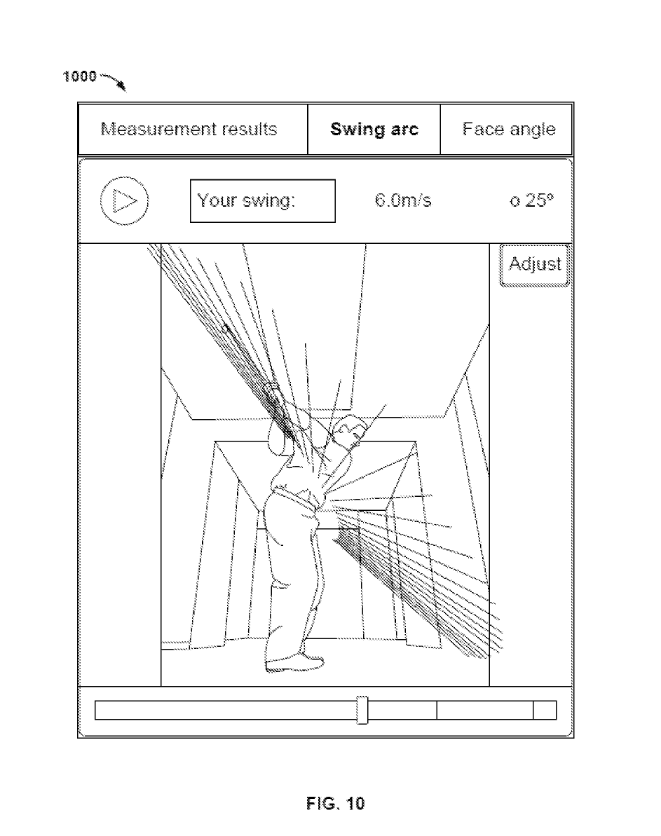

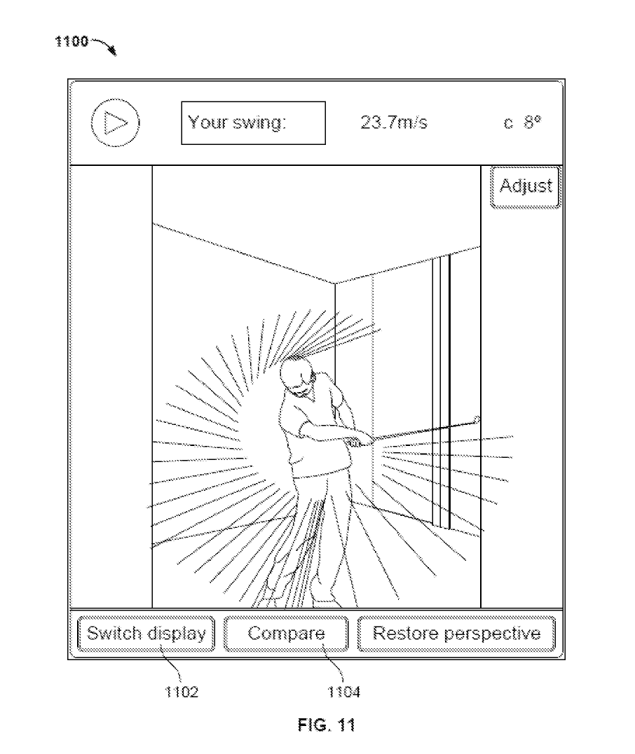

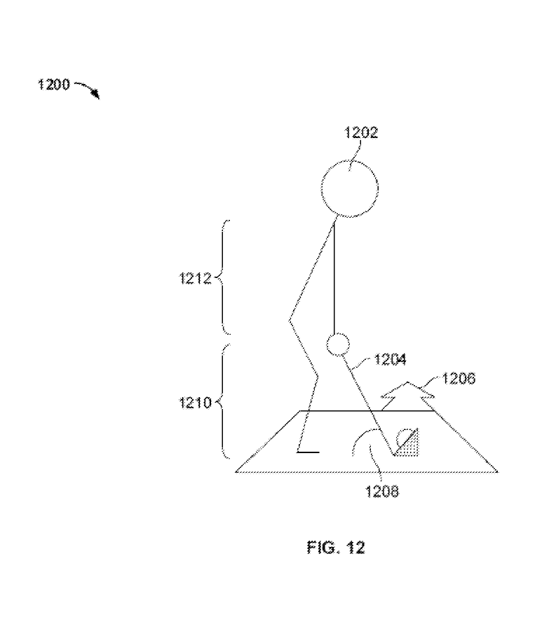

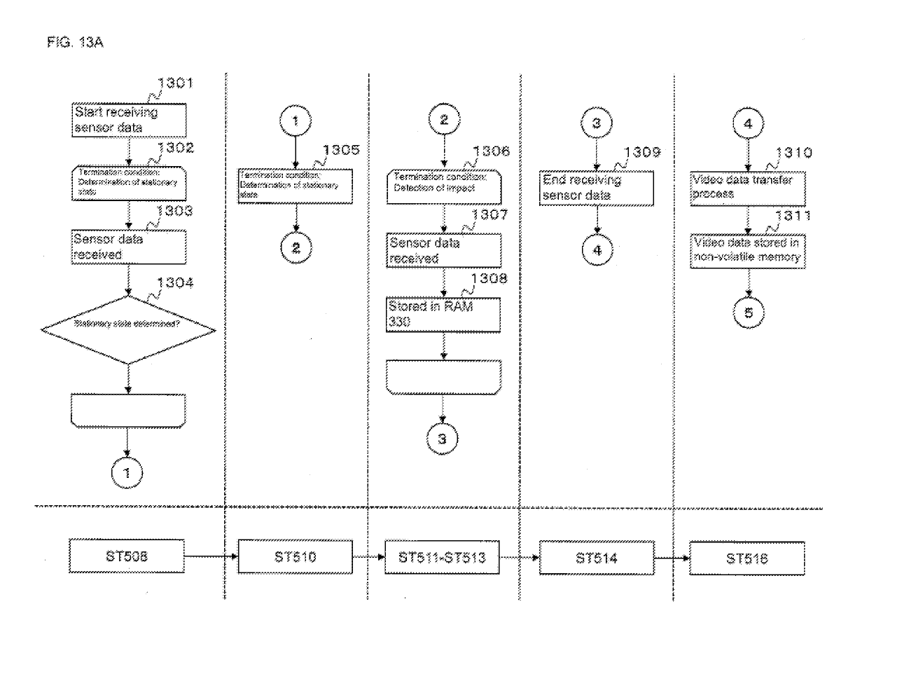

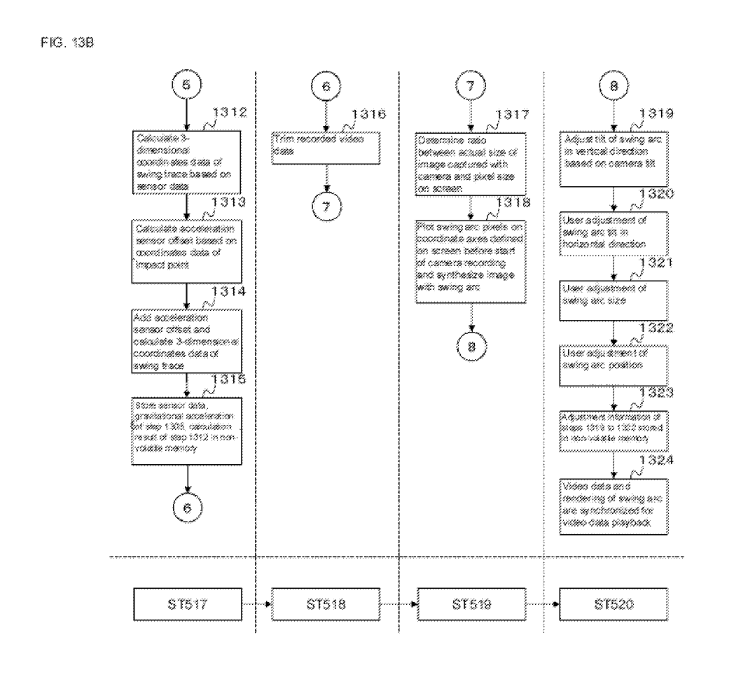

Next, in step 519, the recorded image data that has been trimmed and the moving image that is generated from the corresponding sensor data are overlaid and displayed on display unit 350 of terminal device 300. FIG. 10 shows an example of an image 1000 that is displayed on display unit 350 of terminal device 300 in one embodiment of an analysis system according to the present invention. FIG. 11 shows a different example 1100 of a screen that is displayed on display unit 350 of terminal device 300 in one embodiment of an analysis system according to the present invention. FIG. 11 shows an example of a switch display button 1102, and button for selecting swing data for comparison 1104. As exemplified in FIG. 10 and FIG. 11, recorded data (video data) capturing a player's swing and a moving image (animation) showing the swing trace generated by its corresponding sensor data are overlaid on each other and displayed. The sensor data includes information along the three coordinate axes (X-, Y- and Z-axes) of sensor 100 that is installed on the golf club. Since the information is cross-referenced to time, the information can be used to generate moving images of the swing trace such as those exemplified in FIG. 10 and FIG. 11. The specific method used for overlaying a moving image capturing a swing and a moving image showing the swing trace is described later. In another embodiment, when a moving image of a swing trace that is generated from the sensor data is displayed, the swing trace that includes impact with the golf ball can be displayed in a manner that allows it to be differentiated from other swing traces (such as using a specific color). Because the timing of the impact with a golf ball is identifiable as afore-described, it is also possible to display the image that corresponds to the impact timing in its own special way.

As afore-described, if the player sets up camera 200 as indicated by terminal device 300 and performs a recording while using sensor 100 to measure a swing trace, the player can view the moving image capturing the swing overlaid with the moving image showing the swing trace. However, depending on circumstances, it may not be possible to set up camera 200 in the direction or using the distance to the player that is instructed. In this case, it is possible in step 520 to selectively and manually set the position on the screen of the moving image showing the swing trace while viewing the recorded data so that the position on the screen of the moving image capturing the swing coincides with the position on the screen of the moving image showing the swing trace for the actual position used for camera 200 and the actual distance between the player and camera 200.

Referring again to FIG. 5, a moving image capturing the swing and an image showing the ideal position are overlaid on each other and are displayed on the display in step 521. FIG. 12 is a schematic view 1200 showing the ideal posture of a player/golfer 1202 during a swing in one embodiment of an analysis system according to the present invention. As FIG. 12 shows, when the swing of a player 1202 is viewed from a direction opposite to the direction of flight 1206 of the golf ball, the ideal posture at address can be estimated from the angle 1208 formed between the club 1204 and ground at address, the club length 1210, the height of the player, and the average arm length (statistically derived from height) 1212 for the player's height. It is said that a good golf swing is one where the posture formed at address is maintained during the swing. By overlaying and displaying the ideal posture depicted using line segments—such as that shown in FIG. 12—onto the moving image, the player is assisted in understanding whether his swing is good or bad without having to analyze the video image. This allows the player to efficiently check his own swing without having any knowledge about golf swings in advance. Since the player can also check whether or not the swing plane is on-plane, the player can judge whether the swing plane is good or bad. The specific method for overlaying and displaying a moving image capturing a swing and line segments showing the ideal posture is described later.

Referring again to FIG. 5, it is also possible to selectively assign a numerical score to a player's swing in step 522.

Lastly, even though this is not shown in FIG. 5, it is possible to store the results of the calculations (distance between the player and camera 200, and player's arm length) performed by the afore-described analysis system, set-up information (height, club settings), recorded data, sensor data and the like in non-volatile memory 370 of terminal device 300. The results of the respective measurements that are recorded and the recorded data are cross-referenced to each other using the RDBMS format so that a player (user) can view past data by searching for data using measurement date or measurement result as a search key. Because this simplifies the comparison and verification of current data against data accumulated from the past, golf swings can be practiced more effectively.

The specific method for overlaying and displaying a moving image capturing a swing and a moving image showing the swing trace is described next with reference to FIG. 13A and FIG. 13B. FIG. 13A and FIG. 13B show the program flow from the start of measurement of a swing until the completion of the process for overlaying the coordinates for a recorded data and the moving image showing a swing trace in one embodiment of an analysis system according to the present invention. FIG. 13A and FIG. 13B show process flow representations at the program level of the processes that are performed in steps 508 through 520 in FIG. 5. The processes described below are executed by a program that is stored in ROM 320 of terminal device 300. The correspondence between FIG. 13A and FIG. 13B and the overall process flow shown in FIG. 5 is shown in the bottom row of FIG. 13A and FIG. 13B.

In step 1301, terminal device 300 begins receiving sensor data from sensor 100. In steps 1302 through 1305, terminal device 300 continues to receive sensor data from sensor 100 and measures the acceleration due to gravity in a stationary state, which is required for calculating θ (club lie angle at address) used in equation (2) above. In steps 1306 through 1308, terminal device 300 continues to receive sensor data until sensor 100 detects impact. In step 1309, terminal device 300 stops receiving sensor data from sensor 100.

In step 1310, camera 200 sends to terminal device 300 the video data that was recording during steps 509 through 515. In step 1311, terminal device 300 stores the video data that was received in non-volatile memory 370.

In steps 1312 through 1315, terminal device 300 calculates the swing trace, swing speed and the like from the sensor data. Examples of the method and the algorithm that can be used for their calculation are described in the afore-cited Japanese Patent Application No. 2012-254672. The coordinates of each of the points in the swing trace are calculated from the origin using units of meter. In step 1316, terminal device 300 trims the video data before and after the swing based on the measured time for the swing data that was calculated in steps 1312 through 1315.

In step 1317, based on the horizontal angle of view of the camera and the distance from the camera to the subject, terminal device 300 calculates the relationship between pixels and a meter, that is, how many meters per pixel, so that the swing trace can be converted to pixels. If camera 200 and the subject are facing each other as shown in FIG. 7 (top row) and the player and camera 200 are parallel to each other, the following relationship holds where 0 represents the horizontal angle of view as shown in FIG. 7 (lower row), which shows a view from directly above of the player and camera 200.

Width (m) in the horizontal direction when parallel=2×Distance to the subject×tan(θ/2)

On the other hand, if camera 200 and the subject are facing each other as shown in the top row of FIG. 9 but camera 200 and the player are not parallel to each other as shown in the bottom row of FIG. 9, the following equation holds where S2 represents the tilt of camera 200 with respect to the horizon.

Width (m) in the horizontal direction=Width in the horizontal direction when parallel/cos(Ω)

The resolution of the image is determined by the [image capturing] device and becomes:

Pixel count per meter (px/m)=Image resolution in the horizontal direction÷Width in the horizontal direction

Terminal device 300 calculates the ratio between pixels and a meter as afore-described.

In step 1318, terminal device 300 uses the “pixels per meter” ratio determined in step 1317 to plot the swing arc on the screen. The starting position of the swing arc is origin O, which is the point of intersection between the vertical line and the horizontal line of the human model, set up in step 506 in FIG. 5. The position of origin O on the screen and whether the coordinate plane on the screen is the coordinate plane facing the front direction or the coordinate plane facing the side direction are stored in RAM 330 in step 501. Based on the coordinate plane and the position of the origin that are set, terminal device 300 converts the coordinates of the swing arc into pixels and plots the swing arc. Terminal device 300 uses a memory area different from that used for the video data as the memory area where the swing arc is plotted. The synthesis of the rendered images of the swing arc and the video data can be performed using known image synthesis techniques such as OpenGL.

As exemplified in FIG. 9, there is no guarantee when the camera is actually set up and the distance is determined that the player and camera 200 will be parallel or perpendicular. This means that a tilt in the camera or a difference between the calculated distance and the actual distance between the camera and the player can cause a deviation between the swing arc and the player's swing motion in the images that are synthesized in step 1318. Because these deviations cannot be automatically corrected by a program, it is necessary to provide a user interface that allows the user to adjust the swing arc in the vertical, horizontal and depth directions and to fine tune the size, position and inclination of the swing arc that is synthesized in steps 1319 through 1322.

In step 1323, terminal device 300 stores the results of the adjustments made in steps 1319 through 1322 in non-volatile memory 370. In step 1324, terminal device 300 starts the playback of the video and re-renders the swing trace based on time. By playing back the video data and sequentially plotting the pixels of the swing arc to match the playback speed starting from the timing when the swing motion is started, the swing arc that is displayed appears to be interlinked with the swing motion.

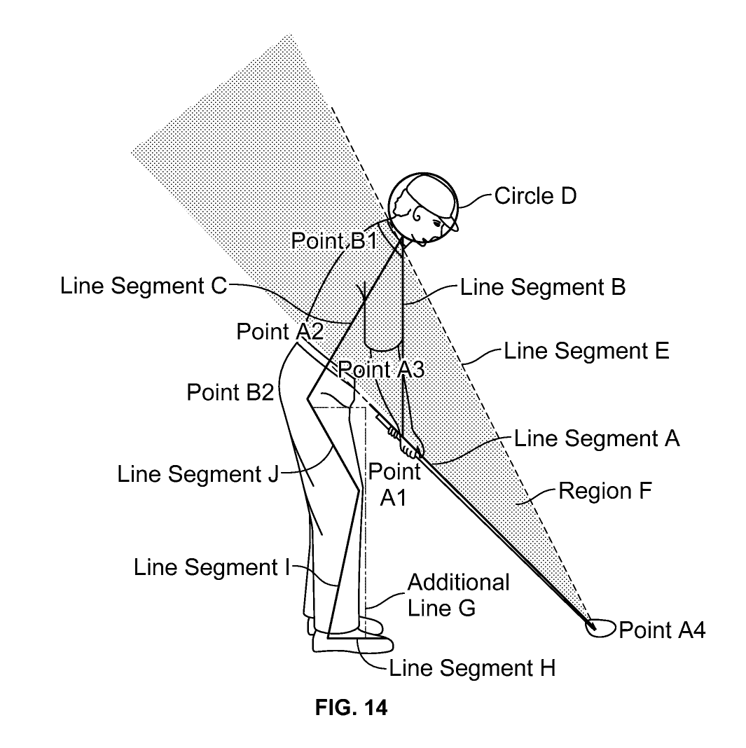

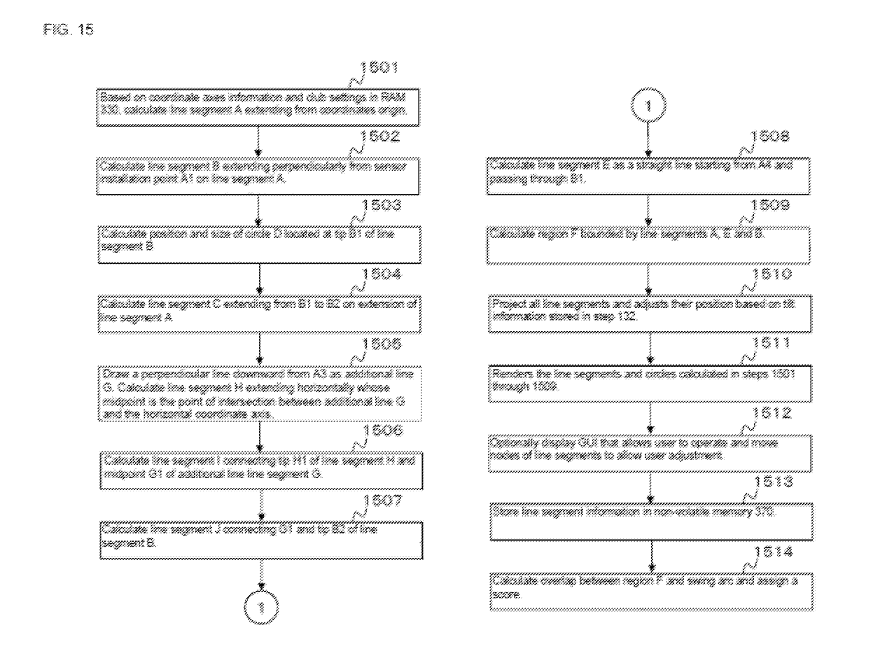

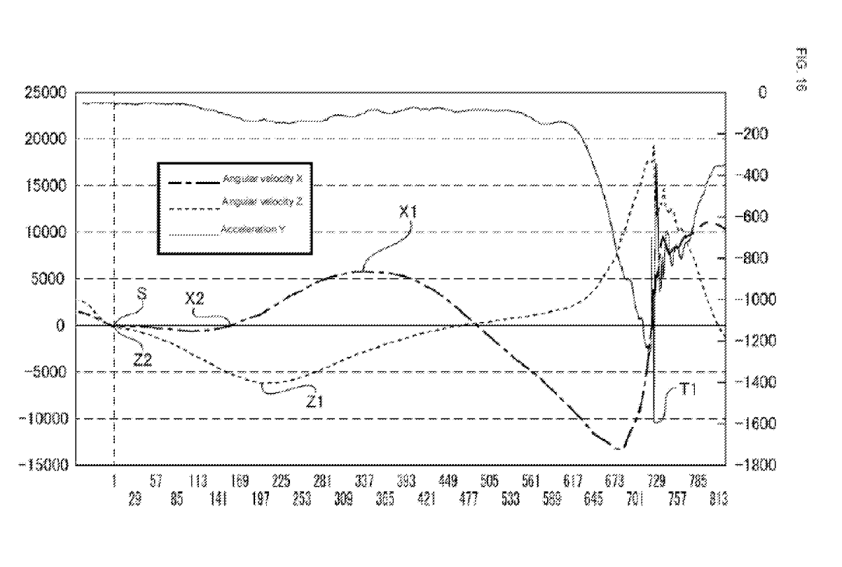

The specific method for overlaying and displaying the moving image capturing the swing and the line segments showing the ideal posture is described next with reference to FIG. 14 and FIG. 15. FIG. 14 shows another example of a screen that is displayed on display unit 350 of terminal device 300 in one embodiment of an analysis system according to the present invention. FIG. 15 is a flowchart showing the process by which line segments are positioned in the image rendering region by the program to overlay the line segments shown in FIG. 14 with the moving image on the screen.

In step 1501, terminal device 300 calculates line segment A that is rendered on the screen starting from origin 0 that was defined in step 506 in FIG. 5 and using the lie angle of the club defined in step 501. The length of line segment A is the club length that is defined in step 501.

In step 1502, terminal device 300 calculates line segment B, which extends in the perpendicular direction from line segment A starting from installation point A1 where sensor 100 is installed. Since the installation point A1 of sensor 100 is to be just below the grip, the installation point A1 will be located on line segment A at a point away from A3—the end of line segment A—by the length of the grip. Since the length of line segment B is equal to the length of the player's arm, grip reach from the back is used as the length of line segment B. Because a good golf swing is said to require both arms holding the club to be hanging perpendicularly toward the ground, line segment B is drawn parallel to the perpendicular direction.

In step 1503, terminal device 300 calculates the size and position of circle D that is located at the end of line segment B at point B1. Because circle D will serve as a mark for the position of the player's head, the diameter of the circle is set to be ⅙ of the player's height. However, if the length in the perpendicular direction of the combination of circle D, line segment B and line segment A starting from origin O exceeds the player's height, terminal device 300 changes the lie angle that was used when calculating line segment A from the lie angle provided as a club information to the actual lie angle at address and recalculates line segment A, line segment B and circle D so that the player's height is not exceeded.

In step 1504, terminal device 300 calculates line segment C, which will be perpendicular to line segment A and starts at point B1. The point where line segment C intersects with a line extending line segment A is defined as A2. The point where a horizontal line extending through A3 intersects with line segment C is defined as B2. Line segment C is a straight line segment extending from B1 to B2 and passing through A2.

In step 1505, a perpendicular line is drawn downward from A3, and this is defined as additional line G. Terminal device 300 calculates line segment H extending horizontally whose midpoint is the point of intersection between additional line G and the horizontal coordinate axis. Line segment H serves as an indicator for the position of the foot. The length of line segment H is set to be one-half of the grip reach from the back.

In step 1506, terminal device 300 calculates line segment I, which connects H1—the end of line segment H— and G1—the midpoint of additional line line segment G. In step 1507, terminal device 300 calculates line segment J, which connects G1 and B2—the tip of line segment B.

In step 1508, terminal device 300 calculates line segment E, which is a straight line starting from A4 and extending through B1. In step 1509, terminal device 300 calculates region F, which is bounded by line segment A, line segment E and line segment B.

If camera 200 is not parallel to the horizontal direction or the perpendicular direction, the line segments that are displayed will be misaligned with the actual image. So, in step 1510, terminal device 300 projects all line segments and adjusts their position based on the tilt information that was stored in step 1323. In step 1511, terminal device 300 renders the line segments, circles and regions that were calculated in steps 1501 through 1509. Because the unit of length of each line segment is the meter, terminal device 300 converts the length using the pixel ratio calculated in step 1317 and renders the line segments.

Terminal device 300 may optionally display a GUI in step 1512 that allows a user to operate and move the nodes of the line segments so as to perform the required adjustments. In step 1513, terminal device 300 stores in non-volatile memory 370 the coordinates information of the line segments, which had been calculated and adjusted in the steps through step 1512. The coordinates information is stored by the user operating a GUI display device of terminal device 300.

In step 1514, terminal device 300 can assign a score to the swing based on the percentage of the swing arc coordinate points that are located within region F. Region F is referred to as the “Ben Hogan plane,” and it is said that it is best for the clubhead to pass through region F during the backswing and the downswing. For this reason, terminal device 300 assigns a higher score when a greater percentage of the swing arc coordinate points passes through region F.

As afore-described, with one embodiment, video data that is generated by a camera and a swing trace that is generated from sensor data are overlaid and displayed on a display. At the same time, the start of the playback of the video data and the start of the rendering of the swing trace are synchronized. This means that, even if, for example, the clubhead is not clearly visible in the video data due to poor performance of the camera, because the swing trace is rendered to correspondent to the video data, whatever (in this case, the clubhead) is unclear in the swing motion that is recorded with the camera is augmented by the swing trace that is measured by the sensor and rendered. This suppresses the occurrence of problems such as the camera performance (e.g., frames per second) being insufficient and causing the motion of the club to become blurred in the video data and the swing to be not sufficiently visible in the video data.

Furthermore, with one embodiment, when a player presses a sensor operation button to start the measurement of a swing, the sensor sends a first specific signal indicating that to a terminal device. When a specific application that is being run on the terminal device receives the first specific signal, the specific application issues a command that starts a camera in the recording mode and begins the recording by the camera. This causes the camera to begin recording in synchrony with the start of the swing by the player. When a sensor detects impact between the clubhead and the golf ball, the sensor sends a second specific signal indicating that to the terminal device. When the specific application running on the terminal device receives the second specific signal, the specific application instructs the camera to stop recording. This causes the camera to stop recording in synchrony with the completion of the swing by the player. This allows a lone player, without a separate operator for operating the camera, to record and measure the swing. Furthermore, the player can start the recording in synchrony with the timing of the swing without using a self-timer.

Furthermore, with one embodiment, a specific application running on a terminal device detects that a player has pressed an operation button on a sensor by receiving a first specific signal and detects that the sensor has detected impact with a golf ball by receiving a second specific signal. Hence, if the start of recording by the camera and the measurement of a swing by the sensor are synchronized, the analysis of the sensor data generated by the sensor allows the determination of the valid swing motion—in terms of its starting time and the ending time—that should remain in the recorded swing motion. This allows unnecessary data that is included in the video data that is generated by the camera to be easily trimmed and eliminates the need for manual trimming of the recorded video data or the manual setting of timing in the recorded video data.

Furthermore, with one embodiment, video data and line segments showing an ideal posture are overlaid and displayed, allowing the player to determine whether the swing is good or bad without requiring the player to analyze the video data or to manually draw lines. Furthermore, the player can check his swing without any knowledge in advance about golf swings.

In the various afore-described embodiments, the example of a terminal device used for the analysis of a player's motion was a terminal device that analyzed the swing of a player holding a golf club. However, the technical philosophy that is disclosed in this specification can be applied to a terminal device that analyzes the motion of a player holding various different apparatuses such as a baseball bat used for softball (baseball), rackets used for tennis/table tennis, different apparatuses used in rhythmic gymnastics, cues used in billiards, fishing rods used in fishing and other apparatuses to which a sensor is attached. Also, if an appropriate or ideal posture that a player should assume exists for that sport, line segments, curves and the like that indicate or suggest such posture can be overlaid and displayed together with a video data capturing the motion of the player so that the player can easily judge whether his motion is good or bad. (For example, with baseball, it is desirable for the level of the eyes to not change from take-back to follow-through. Hence, a guide line extending horizontally can be displayed at the level of the eyes so that the player can check the video data as to whether the level of his eyes changes during the swing.) Furthermore, the technical philosophy that is disclosed in this specification can be used for the analysis of the motion of a player not just using an apparatus on which the sensor is installed but also where no apparatus is used. To explain, the method that is disclosed in this specification can be used for the analysis of a player's motion where the sensor is directly installed on the player's body (as in dancing, karate, swimming, ballet, track and field events and the like).

The processes and procedures described in the specification can be realized not just by the ways that are explicitly described in the embodiments but also by other software, hardware or combination of the two. Specifically, the processes and procedures that are described in the specification can be realized by implementing the logic required for the processes on a medium such as integrated circuits, volatile memory, non-volatile memory, magnetic disk, optical storage and the like. Furthermore, the processes and procedures that are described in the specification can be implemented as computer programs that can be executed on various different computers.

Even if a process or a procedure were explained in the specification as if it were executed on a single device, software, component or module, such process or procedure can be executed using a plurality of devices, plurality of software and plurality of components and/or modules. Furthermore, even if a data, table or database were to be described in the specification as being stored in a single memory, such data, table or database can be stored in a plurality of memory devices installed in a single apparatus or distributed among a plurality of memory devices installed in a plurality of apparatuses. Furthermore, the software and hardware elements that are described in the specification can be realized by integrating them into a smaller number of elements or by decomposing them into a greater number of elements.

What is claimed is:

1. A terminal device comprising:
a moving image acquiring means for acquiring a moving image of a measured subject on which a sensor is installed;
a sensor data acquisition means for acquiring sensor data related to said measured subject from said sensor; and
a display control means for overlaying and displaying said moving image and additional images generated from said sensor data.

2. The terminal device according to claim 1 wherein said display control means synchronizes and displays said moving image and additional moving images showing the trace of said measured subject.

3. The terminal device according to claim 1 wherein said display control means synchronizes and displays said moving image and said additional moving images for a selected time period.

4. The terminal device according to claim 1 wherein:
said terminal device further comprises a control means for controlling an image capturing unit that is disposed either internally or externally to said terminal device for generating a moving image of said measured subject; and
said control means causing said image capturing unit to start an image capturing operation based on the reception of a first specific signal from said sensor and causing said image capturing unit to stop the image capturing operation based on the reception of a second specific signal from said sensor.

5. The terminal device according to claim 1 wherein said display control means overlays and displays said moving image and additional images that show the ideal position of said measured subject.

6. A program that causes a computer to function as:
a moving image acquiring means for acquiring a moving image of a measured subject on which a sensor is installed;
a sensor data acquisition means for acquiring sensor data related to said measured subject from said sensor; and
a display control means for overlaying and displaying said moving image and additional images generated from said sensor data.

7. A display method comprising the steps of:
acquiring a moving image of a measured subject on which a sensor is installed;
acquiring sensor data related to said measured subject from said sensor; and
overlaying and displaying said moving image and additional images generated from said sensor data.

8. A computerized swing analysis system, comprising:
a camera configured to record a video image of a swingable sporting apparatus as it is swung by a user;
a motion sensor configured to be mounted to the swingable sporting apparatus;
a terminal device in electronic communication with the camera and the motion sensor, wherein the terminal device is configured to:
receive the video image from the camera;
wirelessly receive motion sensor data from the motion sensor upon a user's swinging the swingable sporting apparatus;
generate a video image set from the received motion sensor data, the image set comprising a trace of the swingable sporting apparatus; and
overlay the video image of the sporting apparatus and the image set generated from the sensor data to create an overlaid video wherein the video image from the camera and the video image set from the motion sensor is time synchronized; and
a display for displaying the overlaid video.

9. The computerized swing analysis system of claim 8, wherein:
the motion sensor is configured to send a first signal to the camera to start recording the video image; and
the motion sensor is configured to send a second signal to the camera to end recording of the video image.

10. The computerized swing analysis system of claim 9, wherein:
the motion sensor is configured to send the first signal by a user-activated input.

11. The computerized swing analysis system of claim 9, wherein:
the motion sensor is configured to send the second signal when an impact with the swingable sporting apparatus is detected.

12. The computerized swing analysis system of claim 9, wherein:
the camera is configured to end the video image recordation a predetermined time after the second signal is received by the terminal device.

13. The computerized swing analysis system of claim 9, wherein:
the terminal device is configured to remove a portion of the overlaid video prior to a timestamp of the second predetermined signal.

14. The computerized swing analysis system of claim 8, wherein:
the terminal device calculates an optimal distance between the camera and the swingable sporting apparatus based on one or more attributes of the camera, and one or more attributes of the user swinging the swingable sporting apparatus.

15. The computerized swing analysis system of claim 8, wherein:
the motion sensor includes acceleration sensors and angular velocity sensors.

16. The computerized swing analysis system of claim 8, wherein:
the motion sensor further comprises a geomagnetism sensor.

17. The computerized swing analysis system of claim 8, wherein:
the terminal device is configured to:
calculate the ratio of pixels of the display and a unit of distance measurement of the video image captured by the camera, and
apply the calculated ratio to plot the trace on the display.

18. The computerized swing analysis system of claim 8, wherein:
the terminal device is configured to synchronize the video image from the camera and the image set generated from the motion sensor data for a selected time period.

19. The computerized swing analysis system of claim 8, wherein:
the swingable sporting apparatus is one of: a golf club, baseball bat, and tennis racquet.

20. The computerized swing analysis system of claim 8, wherein:
the display is configured to further overlay geometric shapes representing an ideal position of the user on the overlaid video.
